(19) United States
(12) Patent Application Publication
(10) Pub. No.: US 2004/0146624 A1
(43) Pub. Date: Jul. 29, 2004

(54) Soy flour in a sauce for starched based products

(75) Inventors: Donald E. Carpenter, Glenview, IL (US); Wen-Sherng Chen, Glenview, IL (US); Alex Gonsalves, Libertyville, IL (US); Gerard Hasenhuettl, Deerfield, IL (US); Richard Silver, Wilmette, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/756,701

(22) Filed: Jan. 13, 2004

Related U.S. Application Data
(63) Continuation of application No. 09/672,275, filed on Sep. 28, 2000, now abandoned.

(51) Int. Cl. A23L 1/238

(52) U.S. Cl. 426/589

(57) ABSTRACT

A soy protein-containing dry cheese sauce mix containing significant levels of soy protein is provided. The dry cheese sauce mix is prepared by mixing soy flour with dried cheese and cheese flavoring. When used, the dry sauce mix is hydrated to form a cheese sauce suitable for use with starch-based products (e.g., pasta, rice, and the like). The soy protein-containing dry sauce mix of this invention generally contains about 10 to about 75 percent soy flour, about 25 to about 90 percent cheese powder, and about 1 to about 5 percent cheese flavoring. Preferably, the soy protein-containing dry sauce mix contains about 25 to about 50 percent soy flour, about 25 to about 50 percent cheese powder, and about 1 to about 5 percent cheese flavoring. The present invention allows the use of significant levels of soy protein to be included in a sauce for a starch-based product (e.g., macaroni and cheese) and, thereby, provide the health benefits of soy without adversely effecting the organoleptic or other sensory properties of the product.

### FIELD OF THE INVENTION

The present invention is related to a dry cheese sauce mix for use with starch-based products (e.g., pasta, rice, and the like). More specifically, the present invention is related to a dry cheese sauce mix containing significant levels of soy protein for use with starch-based products. The dry cheese sauce mixes of the present invention, when mixed with wet ingredients such as water, milk, margarine, and the like, form sauces suitable for use over starch-based products.

### BACKGROUND OF THE INVENTION

Shelf-stable dinner kits, generally containing most or all the ingredients needed to prepare a main or side dish, are widely available for providing quick and convenient meals. Dinner kits containing a dried cheese blend and dry pasta or parboiled rice are available. Using such dinner kits, a meal or side dish can easily be prepared by reconstituting the dry cheese blend with suitable liquid ingredients (e.g., water or milk) and heating; the resulting cheese sauce can be combined with cooked pasta or rice to complete the final dish. Perhaps one of the most common such dinner kits is macaroni and cheese. As many parents know, children, even those considered finicky eaters, will readily consume macaroni and cheese prepared from such dinner kits and often consider it as “gourmet” fare. It would be desirable, therefore, to provide such dinner kits, suitable for both children and adults, with increased nutritional values and/or other health benefits without significantly impacting the organoleptic properties of the resulting meal or side dish.

The health benefits of soybeans have been known for some time. Along with a tendency to lower cholesterol levels, soybeans have recently been linked with, or suggested as having a possible role in, inhibiting cancerous or tumor cells. Additionally, soy protein contains an amino acid profile that is among the most complete of all vegetable protein sources, and resembles, with the exception of the sulfur-containing amino acids, the pattern derived from high-quality animal protein sources. Thus, efforts have been made to incorporate soy into a wide variety of foods. While there have been many efforts to produce soy-containing cheeses, it has been difficult to incorporate significant levels of soy protein in cheese products which mimic the texture and flavor attributes of natural cheese.

Efforts have also been made to produce processed cheese type products containing soy flour. For example, U.S. Pat. No. 3,982,025 (Sep. 12, 1976) provides a soy cheese spread, similar to a processed cheese product, which is prepared by mixing soy cheese with an edible oil or fat, a cheese emulsifying salt, and water at elevated temperatures to liquify and homogeneously emulsify the ingredients. The soy cheese is prepared by fermenting soy milk with a lactic acid-forming cheese starter culture. The soy cheese may also be treated with a proteolytic enzyme to accelerate the enzymatic degradation of soy globulin; the proteolytic enzyme may be added before fermentation or after cooking the soy cheese curd. The product is described as having a paste-like consistency.

While such soy-containing cheese products may be useful for some applications, they cannot provide the shelf-stability and versatility of a dried cheese blend which can be used to prepare a cheese sauce as needed. Prepared cheese sauces which are processed to be shelf stable may suffer degradation due to harsh heat treatments needed to provide sufficient microbial safety. For example, U.S. Pat. No. 4,568,555 (Feb. 4, 1986) provides a shelf-stable cheese sauce prepared by mixing cheese, lactic acid, dairy protein, and an alkali or alkaline earth metal salt to a mixture of starch, gum, flavoring and water. The blend is then heat sterilized or retorted to provide microbial safety.

Although these methods generally provide cheese-sauce type products which may contain soy, it is still desirable to provide a soy protein-containing cheese sauce which can be stored in dry form and, when desired, can be prepared by incorporation of wet ingredients such as water or milk. The present invention provides dry mix soy protein-containing cheese sauces which can be prepared by incorporation of such wet ingredients for use in or over pasta dishes. The soy protein-containing dry sauce mixes of the present invention are especially useful for incorporation in pasta-based dinner or meal kits such as, for example, macaroni and cheese kits.

### SUMMARY OF THE INVENTION

The present invention generally relates to a cheese sauce and method for preparing a cheese sauce containing significant levels of soy protein. The process uses soy flour mixed with a dried cheese blend to prepare a soy protein-containing dry cheese sauce mix. When used, the dry sauce mix is hydrated to form a cheese sauce suitable for use with starch-based products. The soy protein-containing dry sauce mix of this invention generally contains about 10 to about 75 percent soy flour, about 25 to about 90 percent cheese powder, and about 1 to about 5 percent cheese flavoring. More preferably, the soy protein-containing dry sauce mix of this invention generally contains about 25 to about 50 percent soy flour, about 25 to about 50 percent cheese powder, and about 1 to about 5 percent cheese flavoring. The present invention allows significant levels of soy protein to be included in a sauce for a starch-based or pasta-type product (e.g., macaroni and cheese) and, thereby, provides the health benefits of soy without adversely effecting the organoleptic or other sensory properties of the product. The soy protein-containing dry sauce mixes of this invention are shelf stable; properly packaged, the soy protein-containing dry sauce mixes of this invention can be stored under non-refrigeration (i.e., ambient) conditions for up to about 9 months or longer without significant quality loses.

The soy protein-containing dry sauce mix of this invention contains a soy flour, preferably a low-fat, low-fiber soy flour, as the soy protein ingredient. Preferably the soy flour is heat treated for increased microbial safety prior to its incorporation in the dry sauce mix. To prepare the soy protein-containing dry sauce mixes of this invention, soy flour is dry blended with dried cheese powder, cheese flavoring, and, if desired, optional ingredients (e.g., colorants, other favorings, salt, spices, stabilizers, preservatives, thickeners, and the like) to provide a soy protein-containing cheese sauce mix. Prior to use, the dry sauce mix can be reconstituted by the consumer with wet ingredients (e.g., water, milk, margarine, and the like) to form a cheese sauce containing significant levels of soy protein and which is suitable for use in or over starch-based products (e.g., pasta, rice, and the like).

The present invention also provides a method for preparing a soy protein-containing dry sauce mix, said method comprising: (i) blending about 10 to about 75 percent soy flour, about 25 to about 90 percent cheese powder, and about 1 to about 5 percent cheese flavoring to provide the soy protein-containing dry sauce mix and (2) packaging the soy protein-containing dry sauce mix, wherein a sauce suitable for use with starch-based products can be prepared by reconstituting and heating the soy protein-containing dry sauce mix with a liquid. Preferably, the soy flour is heated toga temperature and for a time sufficient to kill substantially all undesirable microorganisms that may be contained therein prior to being blended with the cheese powder and cheese flavoring. The present soy protein-containing dry sauce mix is ideally suited for use in meal or dinner kits containing starch-based products such as, for example, macaroni and cheese or dinner meal kits.

### DETAILED DESCRIPTION OF THE INVENTION

The present invention generally relates to a cheese sauce and method for preparing a cheese sauce containing significant levels of soy protein. The process uses soy flour mixed with a dried cheese and flavor blend to prepare a soy protein-containing dry cheese sauce mix. When used, the dry sauce mix is hydrated to form a cheese sauce suitable for use with starch-based products. The soy protein-containing dry sauce mix of this invention generally contains about 10 to about 75 percent soy flour, about 25 to about 90 percent cheese powder, and about 1 to about 5 percent cheese flavoring. More preferably, the soy protein-containing dry sauce mix of this invention generally contains about 25 to about 50 percent soy flour, about 25 to about 50 percent cheese powder, and about 1 to about 5 percent cheese flavoring. The present invention allows the use of significant levels of soy protein in a sauce for a starch-based or pasta-type product (e.g., macaroni and cheese) and, thereby, provides the health benefits of soy without adversely effecting the organoleptic or other sensory properties of the product.

The present invention also provides a method for preparing a soy protein-containing dry sauce mix, said method comprising: (1) blending about 10 to about 75 percent soy flour, about 25 to about 90 percent cheese powder, and about 1 to about 5 percent cheese flavoring to provide the soy protein-containing dry sauce mix and (2) packaging the soy protein-containing dry sauce mix, wherein a sauce suitable for use with starch-based products can be prepared by reconstituting and heating the soy protein-containing dry sauce mix with a liquid. Preferably, the soy flour is heated to a temperature and for a time sufficient to kill substantially all undesirable microorganisms that may be contained therein prior to being blended with the cheese powder and cheese flavoring. The present soy protein-containing dry sauce mix is ideally suited for use in meal or dinner kits containing starch-based products such as, for example, macaroni and cheese or dinner meal kits.

The soy protein-containing dry sauce mix of the present invention contains about 10 to about 75 percent soy flour, about 25 to about 90 percent cheese powder, and about 1 to about 5 percent cheese flavoring. More preferably, the soy protein-containing dry sauce mix of the present invention contains about 25 to about 50 percent soy flour, about 25 to about 50 percent cheese powder, and about 1 to about 5 percent cheese flavoring. Optional dry ingredients that may be present in the dry sauce mix include, for example, dairy ingredients (e.g., milk solids, non-fat dry milk, whey protein, lactic acid, lactose, and the like), other flavorants, colorants, salt, spices, thickeners, preservatives, emulsifying agents, and the like. Such optional ingredients, if used, are generally present in levels of about 10 to about 20 percent. Preferred optional ingredients include protein-complexing emulsifiers, such as diacetyltartaric esters of monoglycerides (DATEM), sodium stearoyl lactylate, diglycerides, and the like which tend to reduce chalky or grainy texture; such emulsifiers, if used, are generally present in levels of about 0.5 to about 1.5 percent. Colorants that provide a cheese-like color are generally preferred; especially for children, other colorants can also be used to provide novel colored pasta dishes. An especially preferred soy protein-containing dry sauce mix of the present invention contains 25 to about 50 percent soy flour, about 25 to about 50 percent cheese powder, about 1 to about 5 percent cheese flavoring, about 0.5 to about 1.5 percent of a protein-complexing emulsifier, about 0.02 to about 0.1 percent of a colorant, and about 0.5 to about 1.5 percent salt. The dried cheese sauce mix can be packaged with a starch-based foodstuff such as pasta or rice for use in a dry dinner kit.

Conventional and commercially available soy flours can be used in the practice of the present invention. Generally, however, low-fat, low-fiber soy flours are preferred. Especially preferred soy flours contain about 45 to about 55 percent protein, about 2 to about 9 percent fat, about 10 to about 35 percent carbohydrate, and about 5 to about 18 percent dietary fiber. Even more preferably, soy flours containing about 52 percent protein, about 8 percent fat, about 28 percent carbohydrate, and about 16 percent dietary fiber are used. The particles size of the soy flour is preferably comparable to the particle of the other dry ingredients in the dry sauce mix. Generally, the particle size of the soy flour is about 500 to about 1500 microns, and preferably about 800 to about 1200 microns. Suitable low-fat, low-fiber soy flours are available commercially from, for example Iowa Soy Specialties LLC (Vinton, Iowa) and Cargill Inc. (Minneapolis, Minn.).

The cheese powder is generally a dry blend of dried cheese and, if desired, optional ingredients such as whey protein concentrate, flavorants, colorants, salt, spices, stabilizers, preservatives, thickeners, and the like. Of course, such optional ingredients could be blended with the cheese powder and then blended into the dry mix or blended directly into the dry mix. Preferably, the cheese powder contains whey protein concentrate or sweet whey since these components provide desirable dairy flavors. Suitable cheeses include, for example, cheddar, Swiss, mozzarella, monterey jack, and the like. Preferably cheddar is used. The cheese may be of the full-fat, low-fat, or no-fat type. The dried cheese powders are prepared by conventional techniques. Generally, the dried cheese powder has a moisture content less than about 5 percent and a particle size of about 800 to about 1200 microns.

Cheese flavorings are included in the dry mix, generally at a level of about 1 to about 5 percent, to provide the desired cheese flavor. Preferred cheese flavorings include enzyme modified cheese flavors as described in co-pending U.S. patent application Ser. No. 09/314,713, filed on May 19, 1999; highly flavored components as described in co-pending U.S. patent application Ser. No. 09/141,082, filed on Aug. 27, 1998; and flavored components having specific flavor profiles as described in co-pending U.S patent application Ser. No. 09/659,459, filed on Sep. 12, 2000, and entitled “Natural Biogenerated Cheese Flavoring System.” Each of these applications are owned by the same assignee as the present application and are hereby incorporated by reference. Of course, other cheese flavorings can also be used if desired.

The enzyme-modified cheese flavorings of U.S. patent application Ser. No. 09/314,713, one of the preferred cheese flavorings of this invention, can be prepared by a process including the steps of: (i) contacting a dairy liquid containing whey protein with a proteolytic enzyme to provide a dairy reaction mixture; (ii) incubating the dairy reaction mixture at a temperature and for a period of time that are sufficient to partially hydrolyze proteins; (iii) pasteurizing the partially hydrolyzed dairy reaction mixture; (iv) contacting the pasteurized mixture with a composition comprising a lipase and a cheese culture and incubating for a time and at a temperature that are sufficient for cheese flavor to develop; and (v) treating the fermented mixture with heat sufficient to inactivate the culture, destroy microbial contaminants, and inactivate the enzymes; thereby providing the enzyme-modified cheese flavoring. Complete details regarding preparation and properties of the enzyme-modified cheese flavorings can be found in U.S. patent application Ser. No. 09/314,713, which is incorporated by reference herein.

Another preferred cheese flavorings of this invention includes the highly flavored components described in U.S. patent application Ser. No. 09/141,082. These cheese flavorings can be produced in a relatively short period of time without utilizing a whey draining step or producing cheese curds. A cheese flavor precursor (i.e., an aqueous, acidified protein, and fat substrate) was prepared by mixing together a dried or concentrated protein source, a fat source, an acid source, and water. An enzyme system was then added to the substrate. The enzyme system included a lipase, a protease, and a peptidase. The substrate was then fermented for a time sufficient to provide a highly developed cheese flavor in the substrate. The substrate was then heated to a temperature and held at that temperature for a time sufficient to inactivate the enzyme system. Complete details regarding the preparation and properties of the highly flavored components can be found in U.S. patent application Ser. No. 09/141,082, which is incorporated by reference herein.

Still other preferred cheese flavorings are described in U.S. patent application Ser. No. 09/659,459 entitled “Natural Biogenerated Cheese Flavoring System.” This application provides a cheese flavoring system comprising a sulfury-cheddar flavor component, a creamy-buttery flavor component, and a cheesy flavor component. These flavoring components can be used singly or in combination as cheese flavorings in the present invention. The sulfury-cheddar flavor component is prepared by treating a first milk concentrate with a lactic acid culture, and optionally a lipolytic enzyme and a high proteolytic activity culture, at a temperature of about 70 to about 86° F. for about 10 to about 24 hours to obtain first mixture having a pH of about 5.4 or less, adding a sulfur-containing substrate to the first mixture to form a second mixture, treating the second mixture with a Brevibacterium linens culture or a yeast from the genera Debaromyces or Kluyeromyces, whereby the Brevibacterium linens culture or the yeast can convert the sulfur-containing substrate to sulfur-containing flavor compounds, at a temperature of about 65 to about 86° F. for about 3 to about 10 days to form a third mixture, and treating the third mixture at a temperature sufficient to inactivate the cultures and enzymes in the third mixture to form the sulfury-cheddar flavor component. The creamy-buttery flavor component is prepared by treating a second milk concentrate with a lactic acid culture, and optionally a lipolytic enzyme, at a temperature of about 70 to about 86° F. for about 10 to about 24 hours to form a fourth mixture, adding sodium citrate to the fourth mixture to form a fifth mixture, treating the fifth mixture with a diacetyl-producing flavor culture at about 70 to about 90° F. for about 1 to about 10 days to form a sixth mixture, and treating the sixth mixture at a temperature sufficient to inactivate the cultures and enzymes in the sixth mixture to form the creamy-buttery flavor component. The cheesy flavor component is prepared by treating a third milk concentrate with a lipase, a protease, and a peptidase at a temperature of about 60 to about 140° F. for about 0.5 to about 10 days to form a seventh mixture and treating the seventh mixture at a temperature sufficient to inactivate enzymes in the seventh mixture to form the cheesy flavor component. Complete details regarding the preparation and properties of the sulfury-cheddar flavor component, the creamy-buttery flavor component, and the cheesy flavor component can be found in U.S. patent application Ser. No. 09/659,459 entitled “Natural Biogenerated Cheese Flavoring System,” which is incorporated by reference herein.

In preparing the soy protein-containing dry sauce mix of the present invention, the soy flour is preferably heated to about 80 to about 90° F. for about 3 to about 10 minutes to kill or inactivate substantially all undesirable microorganisms that may be present in the soy flour. The soy flour, cheese powder, and cheese flavoring are dry blended using conventional techniques and equipment to provide an essentially homogenous dry mix. Preferably, the dry mix contains less than about 5 percent moisture and has a particle size of about 800 to 1200 microns. The dry mix can then be packaged in suitable containers such as, for example, moisture proof pouches, packets, or the like. The packaged dry mix is preferably packaged with a suitable starch-based product (e.g., pasta, rice, and the like) in a meal or dinner kit. An especially preferred meal or dinner kit is macaroni and cheese.

The following examples are intended to illustrate the invention and not to limit it. Unless otherwise indicated, all percentages are by weight.

### EXAMPLE 1

### Macaroni and Cheese

Control. A commercially available macaroni and cheese kit contained dried macaroni and a separately packaged cheese blend was used as the control. The macaroni and cheese was prepared in a microwave oven following the printed cooking instructions. Once the macaroni had been cooked, the cheese blend, milk, and margarine in the recommended amounts were added and blended throughly with the macaroni. The cheese blend contained about 12 percent dried cheddar cheese, about 17 percent whey protein concentrate, about 14 percent salts, about 0.5 percent cheese flavor, and about 0.1 percent coloring.

### EXAMPLE 2

Macaroni and Cheese with 25 Percent Soy Flour. Using the cheese blend from Example 1., a 25 percent soy flour cheese blend was prepared by reducing the amount of the cheese blend by 25 percent and adding a corresponding amount of soy flour. The soy flour was from Iowa Soy Specialties and contained about 52 percent protein, about 8 percent fat, about 14 percent carbohydrate, and about 16 percent dietary fiber. The macaroni and cheese dish was prepared using the same procedure as in Example 1. The macaroni and cheese prepared with 25 percent soy flour was comparable to the control sample of Example 1.

### EXAMPLE 3

Macaroni and Cheese with 50 Percent Soy Flour. Using the same materials and procedures as in Examples 1 and 2, a cheese blend containing 50 percent soy flour was prepared. About 1 percent enzyme modified cheese flavor, about 1 percent salt, and about 0.03 percent coloring was added to the cheese blend. The enzyme modified cheese flavor was prepared as described in co-pending U.S. patent application Ser. No. 09/314,713. The macaroni and cheese dish was prepared using the same procedure as in Example 1. Generally, the dish was somewhat less desirable than the control, having less cheese-like color and flavor. Additional or stronger cheese flavorings and/or colorings can be used to improve flavor and color.

### EXAMPLE 4

Macaroni and Cheese with 50 Percent Soy Flour and Increased Cheese Flavor. A cheese blend was prepared as in Example 3 except that the amount of the enzyme modified cheese powder was increased to 5 percent. This resulted in improved flavor characteristics Example 5: Macaroni and Cheese with 100 Percent Soy Flour. A dry sauce mix was prepared without using any of the cheese blend of Example 1. The dry sauce mix contained soy flour with varying levels of the enzyme modified cheese powder, about 1 percent salt, and about 0.03 percent coloring. Sample A contained 1 percent enzyme modified cheese powder; sample B contained 5 percent enzyme modified cheese powder. The enzyme modified cheese powder was the same as used in Example 3. Dry sauce mixes containing such high levels of soy flour were generally unacceptable as they were chalky and substantially lacking in cheese flavor.

### EXAMPLE 6

Rice and Cheese Sauce. Rice and cheese sauce combination were prepared using the same basic cheese blend as used in Example 1. For the control sample, parboiled rice (60 g), water (about 1 cup), margarine (2 teaspoons), milk (about one 1 cup), and dried cheese blend (33.7 g) were blended in a 3 lb microwave-safe dish and then heated covered in a microwave oven for about 7 minutes. Inventive samples were prepared in a similar manner except the cheese blend was modified, using the same procedure as in Example 2, with either 25 or 50 percent soy flour. The soy flour used was the same as in Example 2. The rice and cheese combination prepared with the 25 percent soy flour sample was comparable to the control sample. The rice and cheese combination prepared with the 50 percent soy flour sample was less acceptable with a reduction in overall cheese flavor and salty notes. Incorporation of additional cheese flavoring and salt are expected to overcome these defects.

What is claimed is:

1. A soy protein-containing dry sauce mix comprising about 10 to about 75 percent soy flour, about 25 to about 90 percent cheese powder, and about 1 to about 5 percent cheese flavoring, wherein the dry sauce mix can be used to prepare a soy protein-containing sauce to be combined with a cooked starch-based product, thereby, providing significant levels of soy protein without significantly and adversely effecting the organoleptic or other sensory properties of the combined sauce and cooked starch-based product.

2. The soy protein-containing dry sauce mix, wherein the soy flour is present at about 25 to about 50 percent soy flour, cheese powder is present at about 25 to about 50 percent, and cheese flavoring at about 1 to about 5 percent.

3. The soy protein-containing dry sauce mix of claim 2, wherein the soy flour is a low-fat, low-fiber soy flour.

4. The soy protein-containing dry sauce mix of claim 3, wherein the soy flour contains about 45 to about 55 percent protein, about 2 to about 9 percent fat, about 10 to about 35 percent carbohydrate, and about 5 to about 18 percent dietary fiber.

5. The soy protein-containing dry sauce mix of claim 2 further comprising about 0.5 to about 1.5 percent of a protein-complexing emulsifier, about 0.02 to about 0.1 percent of a colorant, and about 0.5 to about 1.5 percent salt.

6. The soy protein-containing dry sauce mix of claim 3 further comprising about 0.5 to about 1.5 percent of a protein-complexing emulsifier, about 0.02 to about 0.1 percent of a colorant, and about 0.5 to about 1.5 percent salt.

7. The soy protein-containing dry sauce mix of claim 2, wherein the soy flour is heat treated at a temperature of about 80 to about 90° F. for about 3 to about 10 minutes to kill or inactivate substantially all undesirable microorganisms that may be present in the soy flour.

8. The soy protein-containing dry sauce mix of claim 3, wherein the soy flour is heat treated at a temperature of about 80 to about 90° F. for about 3 to about 10 minutes to kill or inactivate substantially all undesirable microorganisms that may be present in the soy flour.

9. The soy protein-containing dry sauce mix of claim 6, wherein the soy flour is heat treated at a temperature of about 80 to about 90° F. for about 3 to about 10 minutes to kill or inactivate substantially all undesirable microorganisms that may be present in the soy flour.

10. A dinner or meal kit suitable for preparing a sauce and starch-based product dish, said kit comprising a starch-based product and a separately-packaged soy protein-containing dry sauce mix, wherein the soy protein-containing dry sauce mix comprises about 10 to about 75 percent soy flour, about 25 to about 90 percent cheese powder, and about 1 to about 5 percent cheese flavoring, wherein the dry sauce mix can be used to prepare a soy protein-containing sauce to be combined with the starch-based product after cooking, thereby, providing significant levels of soy protein without significantly and adversely effecting the organoleptic or other sensory properties of the sauce and starch-based product dish.

11. The dinner or meal kit of claim 1 0, the soy protein-containing dry sauce mix comprises about 25 to about 50 percent soy flour, about 25 to about 50 percent cheese powder, and about 1 to about 5 percent cheese flavoring.

12. The dinner or meal kit of claim 11, wherein the soy flour is a low-fat, low-fiber soy flour.

13. The dinner or meal kit of claim 12, wherein the soy flour contains about 45 to about 55 percent protein, about 2 to about 9 percent fat, about 10 to about 35 percent carbohydrate, and about 5 to about 18 percent dietary fiber.

14. The dinner or meal kit of claim 11 further comprising about 0.5 to about 1.5 percent of a protein-complexing emulsifier, about 0.02 to about 0.1 percent of a colorant, and about 0.5 to about 1.5 percent salt.

15. The dinner or meal kit of claim 12 further comprising about 0.5 to about 1.5 percent of a protein-complexing emulsifier, about 0.02 to about 0.1 percent of a colorant, and about 0.5 to about 1.5 percent salt.

16. The dinner or meal kit of claim 1 1, wherein the soy flour is heat treated at a temperature of about 80 to about 90° F. for about 3 to about 10 minutes to kill or inactivate substantially all undesirable microorganisms that may be present in the soy flour.

17. The dinner or meal kit of claim 12, wherein the soy flour is heat treated at a temperature of about 80 to about 90° F. for about 3 to about 10 minutes to kill or inactivate substantially all undesirable microorganisms that may be present in the soy flour.

18. The dinner or meal kit of claim 15, wherein the soy flour is heat treated at a temperature of about 80 to about 90° F. for about 3 to about 10 minutes to kill or inactivate substantially all undesirable microorganisms that may be present in the soy flour.

19. The dinner or meal kit of claim 11, wherein the starch-based product is macaroni.

20. The dinner or meal kit of claim 12, wherein the starch-based product is macaroni.

21. The dinner or meal kit of claim 15, wherein the starch-based product is macaroni.

22. The dinner or meal kit of claim 18, wherein the starch-based product is macaroni.

23. A method for preparing a soy protein-containing dry sauce mix, said method comprising: (1) blending about 10 to about 75 percent soy flour, about 25 to about 90 percent cheese powder, and about 1 to about 5 percent cheese flavoring to provide the soy protein-containing dry sauce mix and (2) packaging the soy protein-containing dry sauce mix, wherein a sauce suitable for use with a starch-based product can be prepared by reconstituting and heating the soy protein-containing dry sauce mix with a liquid.

24. The method as in claim 23, wherein the soy protein-containing dry sauce mix contains about 25 to about 50 percent soy flour, about 25 to about 50 percent cheese powder, and about 1 to about 5 percent cheese flavoring.

25. The method as in claim 24, wherein the soy flour wherein the soy flour is heat treated at a temperature of about 80 to about 90° F. for about 3 to about 10 minutes to kill or inactivate substantially all undesirable microorganisms that may be present in the soy flour.

26. The method as in claim 25, wherein the soy flour is a low-fat, low-fiber soy flour.

27. The method as in claim 26, wherein the soy flour contains about 45 to about 55 percent protein, about 2 to about 9 percent fat, about 10 to about 35 percent carbohydrate, and about 5 to about 18 percent dietary fiber.

28. The method as in claim 26, wherein about 0.5 to about 1.5 percent of a protein-complexing emulsifier, about 0.02 to about 0.1 percent of a colorant, and about 0.5 to about 1.5 percent salt are blended with the, soy flour, cheese powder, and cheese flavoring.
